(19) United States
(12) Patent Application Publication
(10) Pub. No.: US 2017/0047571 A1
(43) Pub. Date: Feb. 16, 2017

(54) RECTANGULAR ELECTRICITY STORAGE DEVICE AND METHOD FOR PRODUCING RECTANGULAR ELECTRICITY STORAGE DEVICE

(71) Applicant: Sumitomo Electric Industries, Ltd., Osaka-shi (JP)

(72) Inventors: Mizuo Iwasaki, Osaka-shi (JP); Yasushi Mochida, Osaka-shi (JP); Takeshi Araya, Nakakoma-gun (JP)

(73) Assignee: Sumitomo Electric Industries, Ltd., Osaka-shi (JP)

(21) Appl. No.: 15/306,909

(22) PCT Filed: Apr. 28, 2015
(86) PCT No.: PCT/JP2015/062815

§ 371 Date: Oct. 26, 2016

(30) Foreign Application Priority Data
May 2, 2014 (JP) 2014-095170
Oct. 9, 2014 (JP) 2014-207936

(51) Int. Cl. H01M 2/18; H01M 2/34; H01M 2/04; H01M 10/04

(52) U.S. Cl. CPC H01M 2/18; H01M 10/04; H01M 2/34; H01M 2/043; H01M 2220/20

(57) ABSTRACT

A rectangular electricity storage device includes a prism-shaped electrode group with an upper surface, a lower surface, and four lateral surfaces, the electrode group including a positive electrode, a negative electrode, and a separator interposed between the positive electrode and the negative electrode; an electrolyte; a case with an opening portion, the ease housing the electrode group and the electrolyte; a cover plate covering the opening portion of the case; and an insulation sheet interposed between the electrode group and the case, and insulating the electrode group and the case from each other, wherein the insulation sheet is folded so as to surround the lower surface and the four lateral surfaces of the electrode group.

### TECHNICAL FIELD

The present invention relates to a rectangular electricity storage device including an electrode group that is a multilayer body prepared by alternately stacking sheet-shaped positive electrodes and sheet-shaped negative electrodes, or that is a wound body prepared by winding a laminate of a sheet-shaped positive electrode and a sheet-shaped negative electrode, and also relates to a method for producing the rectangular electricity storage device.

### BACKGROUND ART

Conventional rectangular electricity storage devices each include an electrode group that is, for example, a multilayer body prepared by alternately stacking sheet-shaped positive electrodes and sheet-shaped negative electrodes with separators interposed between the electrodes, or that is a wound body prepared by winding, a laminate of a positive electrode and a negative electrode with a separator interposed therebetween. Here, “rectangular electricity storage devices” encompass electricity storage devices having the shape of a prism resembling a rectangular parallelepiped, and electricity storage devices having the shape of a flat prism with rounded opposite lateral faces and rounded corners.

In general, the case of a rectangular electricity storage device has a shape corresponding to the shape of the electrode group. When an electrode group is a multilayer body, the electrode group has the shape of a prism resembling a rectangular parallelepiped. As a result, the rectangular electricity storage device also has an outer shape resembling the rectangular parallelepiped. When an electrode group is a wound body, the electrode group has the shape of a prism having curved surfaces as opposite lateral faces. As a result, the rectangular electricity storage device also has an outer shape having curved surfaces as opposite lateral faces.

Such an electrode group is inserted, into rectangular case with an opening portion. After the electrode group is inserted into the case, a cover plate is attached to the opening portion of the case. Subsequently, electrolyte .is poured through an opening in the cover plate into the case. Subsequently, processes such as degassing are performed and the opening of the cover plate is closed. Thus, the rectangular electricity storage device is sealed.

In general, such a case is formed of metal and has conductivity. The case having conductivity has a configuration of having the polarity of the positive electrode or the negative electrode, or has a configuration of not having polarities of these electrodes.

In the former configuration, a contact of the case with an electrode having a polarity opposite to that of the case results in an internal short-circuit of the electricity storage device. In the latter configuration, contacts of both of the positive electrode and the negative electrode with the case also result in an internal short-circuit of the electricity storage device. For this reason, in general, an insulation sheet or the like is disposed between the electrode group and the case (refer to Patent Literature 1).

As described in Patent Literature 1, the insulation sheet may be shaped so as to have a bag shape that houses the electrode group. At this time, for example, a single insulation sheet is folded in half and peripheries of the resultant overlapping portion are joined together by thermal welding to provide the bag shape. Alternatively, two insulation sheets are placed on top of each other and peripheral portions thereof are joined together by thermal welding to provide the bag shape. However, such joining processes are not limited to thermal welding.

Alternatively, a heat-shrinkable tube is used to cover the four lateral surfaces of a prism-shaped electrode group, and a bottom insulation plate is disposed between the lower surface (bottom surface) of the electrode group and the bottom of the case. In this way, an internal short-circuit in the electricity storage device is prevented, which is a common practice.

### CITATION LIST

### Patent Literature

PTL 1: Japanese Unexamined Patent Application Publication No. 2009-26704

### SUMMARY OF INVENTION

### Technical Problem

As described above, conventionally, thermal welding is employed to form a bag from an insulation sheet, and the bag is used to house an electrode group therein to provide insulation between the electrode group and a case. Alternatively, a heat-shrinkable tube and a bottom insulation plate are employed to provide insulation between an electrode group and a case.

However, formation of bags from insulation sheets requires, other than the assembly line of electricity storage devices, an additional line of forming bags of insulation sheets with, for example, a thermal-welding apparatus. This results in an increase in the scale of the facility for manufacturing electricity storage devices and also an increase in the complexity of the production process of electricity storage devices, which causes an increase in the production costs.

Also, the use of a heat-shrinkable tube and a bottom insulation plate requires, for example, the step of placing the bottom insulation plate into the case, the step of attaching the heat-shrinkable tube to the electrode group, and the step of shrinking the heat-shrinkable tube. This results in an increase in the complexity of the production process of electricity storage devices.

### Solution to Problem

An aspect of the present invention relates to a rectangular electricity storage device including:

a prism-shaped electrode group with an upper surface, a lower surface, and four lateral surfaces, the electrode group including a positive electrode, a negative electrode, and a separator interposed between the positive electrode and the negative electrode;

an electrolyte;

a case with an opening portion, the case housing the electrode group and the electrolyte;

a cover plate covering the opening portion of the case; and

an insulation sheet interposed between the electrode group and the case, and electrically insulating the electrode group and the case from each other,

wherein the insulation sheet is folded so as to surround the lower surface and the four lateral surfaces of the electrode group.

Another aspect of the present invention relates to a method for producing a rectangular electricity storage device, the method including:

(a) a step of preparing a prism-shaped electrode group with an upper surface, a lower surface, and four lateral surfaces, the electrode group including a positive electrode, a negative electrode, and a separator interposed between the positive electrode and the negative electrode;

(b) a step of preparing an electrolyte;

(c) a step of preparing a case with an opening portion, the case being used for housing the electrode group and the electrolyte;

(d) a step of preparing a cover plate for covering the opening portion of the case;

(e) a step of preparing an insulation sheet for being interposed between the electrode group and the case so as to electrically insulate the electrode group and the case from each other;

(f) a step of folding the insulation sheet so as to surround the lower surface and the four lateral surfaces of the electrode group; and

(g) a step of placing the electrode group and the folded insulation sheet into the case such that the insulation sheet is interposed between the electrode group and the case.

### Advantageous Effects of Invention

The present invention enables simplification of the production process and production equipment for rectangular electricity storage devices.

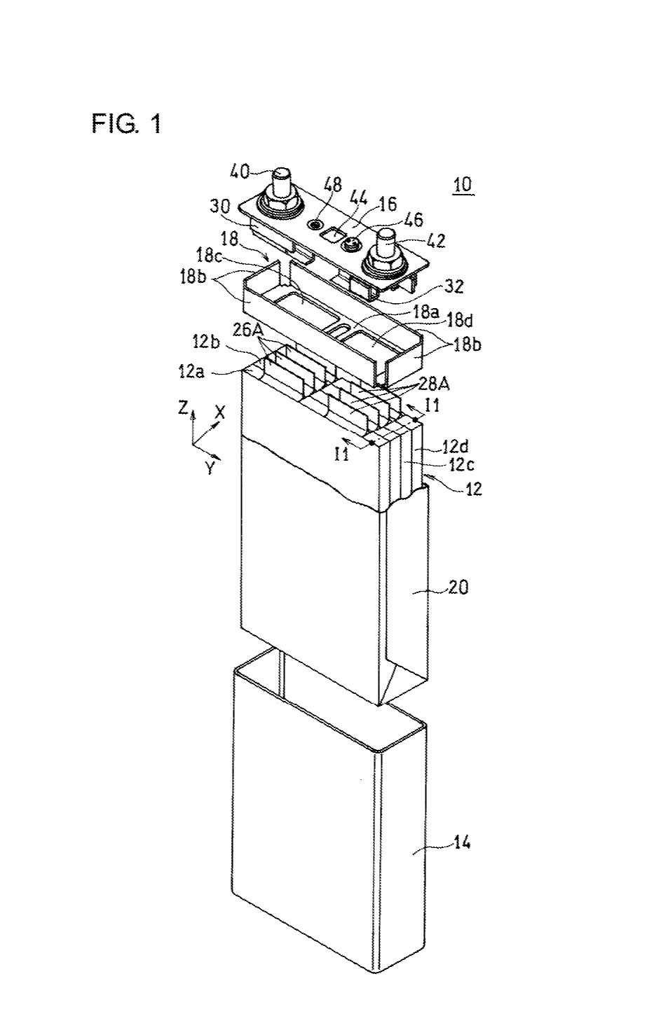

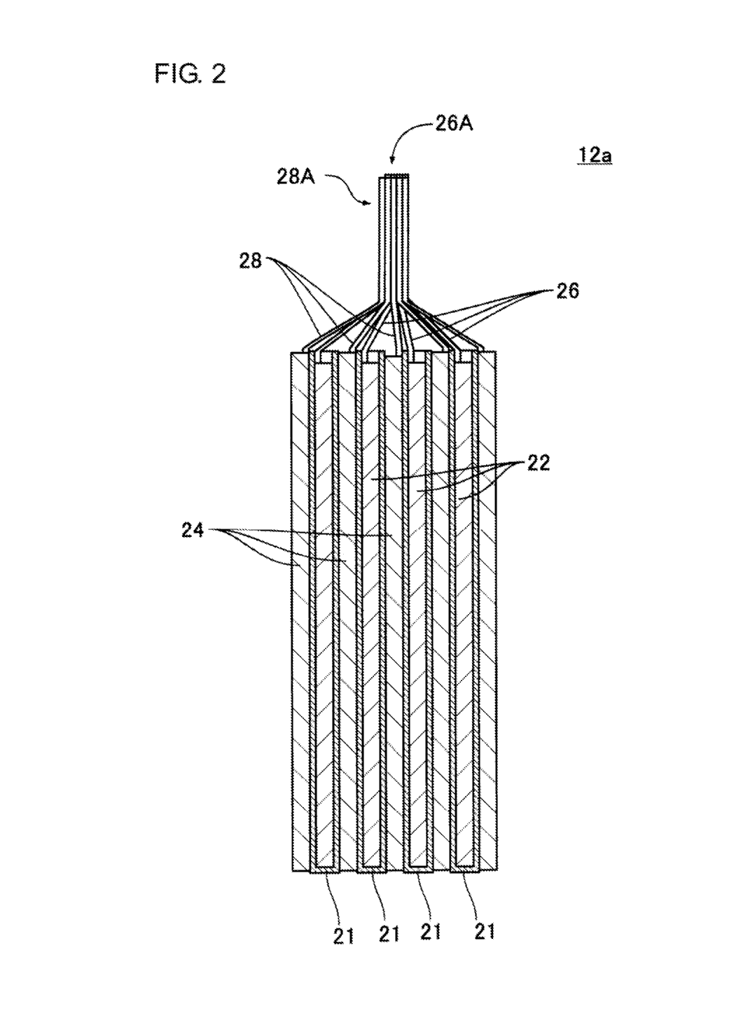

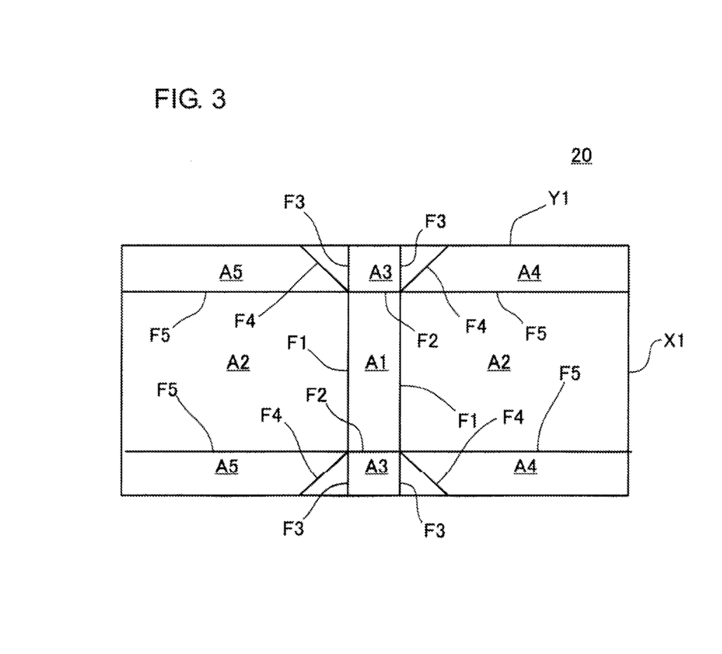

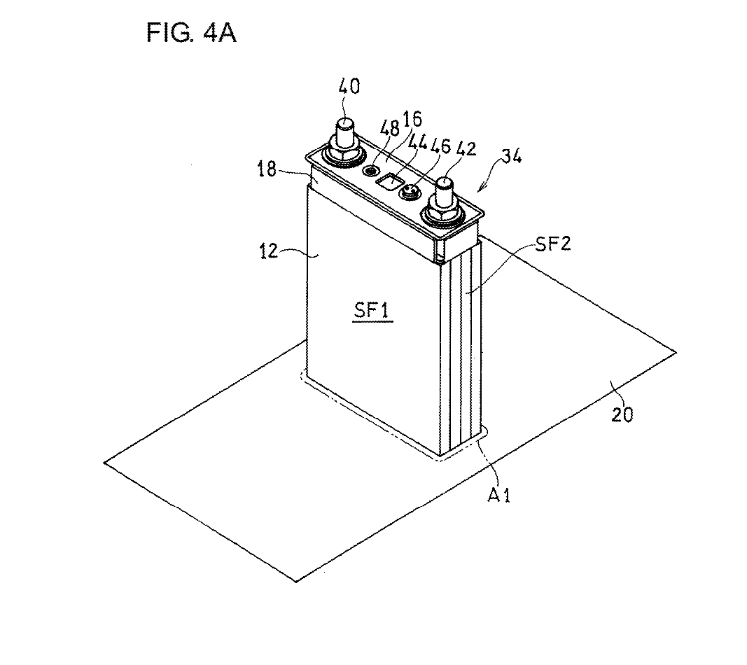

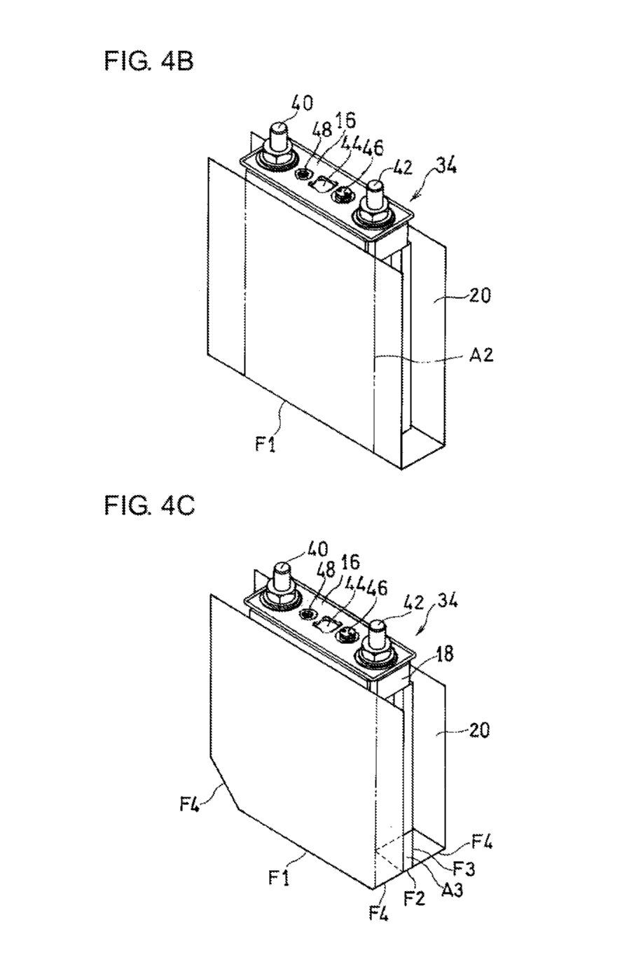

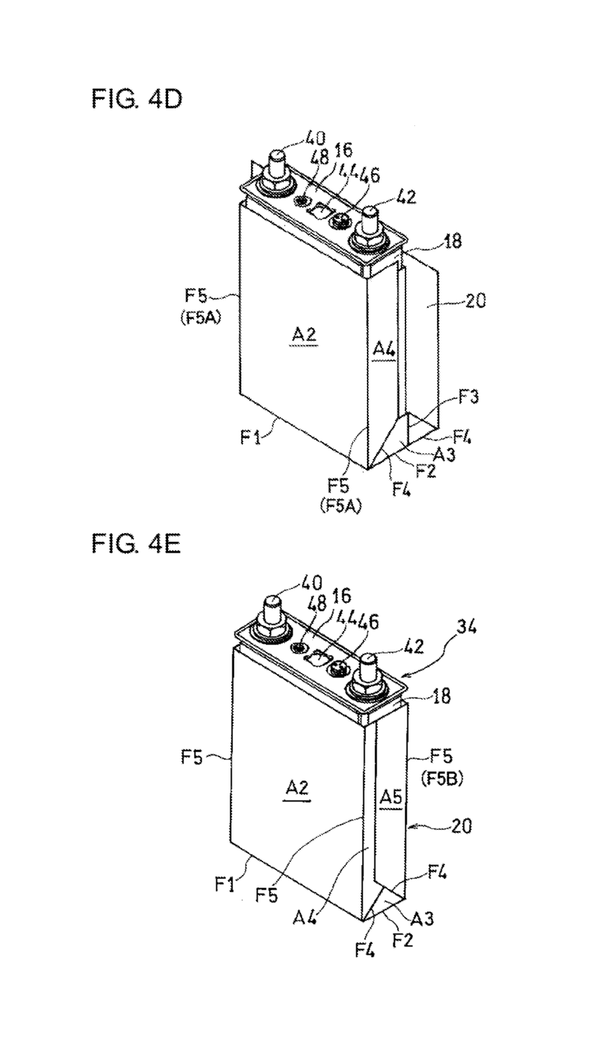

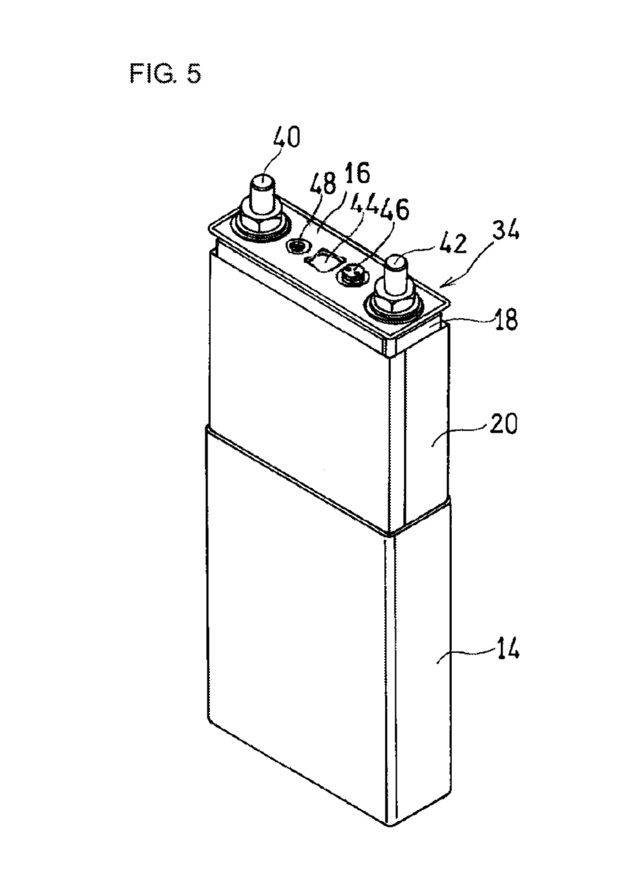

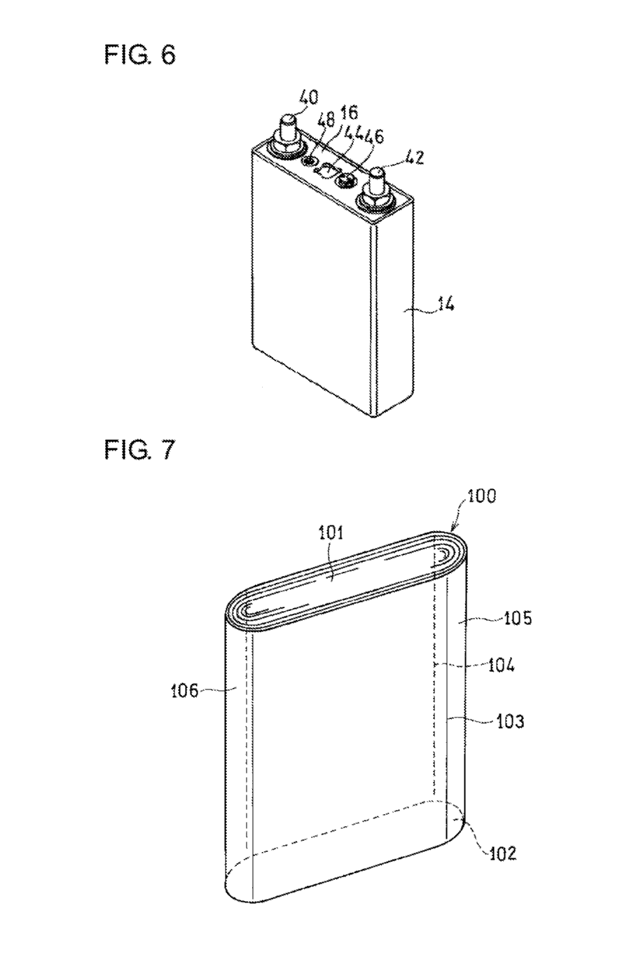

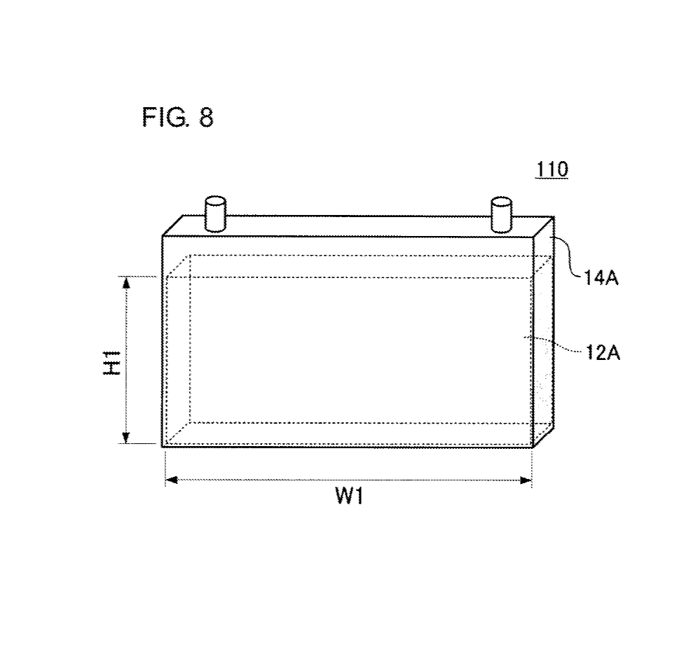

### BRIEF DESCRIPTION OF DRAWINGS

[FIG. 1] FIG. 1 is an exploded perspective view schematically illustrating the configuration of a rectangular electricity storage device according to an embodiment of the present invention.

[FIG. 2] FIG. 2 is a sectional view of a sub-group of the electrode group, taken along line I1-I1 in FIG. 1 and viewed in the direction of the arrows.

[FIG. 3] FIG. 3 is a plan view of an unfolded insulation sheet.

[FIG. 4A] FIG. 4A is a perspective view illustrating a first step of a process of folding an insulation sheet so as to surround the lower surface and four lateral surfaces of an electrode group.

[FIG. 4B] FIG. 4B is a perspective view illustrating a second step of a process of folding an insulation sheet so as to surround the lower surface and four lateral surfaces of an electrode group.

[FIG. 4C] FIG. 4C is a perspective view illustrating a third step of a process of folding an insulation sheet so as to surround the lower surface and four lateral surfaces of an electrode group.

[FIG. 4D] FIG. 4D is a perspective view illustrating a fourth step of a process of folding an insulation sheet so as to surround the lower surface and four lateral surfaces of an electrode group.

[FIG. 4E] FIG. 4E is a perspective view illustrating a fifth step of a process of folding an insulation sheet so as to surround the lower surface and four lateral surfaces of an electrode group.

[FIG. 5] FIG. 5 is a perspective view illustrating a step of inserting, into a case, an intermediate product in which the lower surface and four lateral surfaces of an electrode group are surrounded by an insulation sheet.

[FIG. 6] FIG. 6 is a perspective view illustrating a case housing an intermediate product in which the lower surface and four lateral surfaces of an electrode group are surrounded by an insulation sheet.

[FIG. 7] FIG. 7 is a perspective view illustrating the outer shape of a wound body prepared by winding a positive electrode and a negative electrode with a separator interposed therebetween.

[FIG. 8] FIG. 8 is a perspective view illustrating an example of a wide type of a rectangular electricity storage device.

### DESCRIPTION OF EMBODIMENTS

A rectangular electricity storage device according to an embodiment of the present invention includes a prism-shaped electrode group with an upper surface, a lower surface, and four lateral surfaces, the electrode group including a positive electrode, a negative electrode, and a separator interposed between the positive electrode and the negative electrode; an electrolyte; a case with an opening portion, the case housing the electrode group and the electrolyte; a cover plate covering the opening portion of the case; and an insulation sheet interposed between the electrode group and the case, and electrically insulating the electrode group and the case from each other. The insulation sheet is folded so as to surround the lower surface and the four lateral surfaces of the electrode group. Two or more insulation sheets may be used.

Here, “prism-shaped” encompasses, for example, rectangular-parallelepiped shapes and rectangular-parallelepiped-like shapes having rounded lateral faces and rounded corners. Such an electrode group that is prism-shaped has an upper surface, a lower surface, and four lateral surfaces. The electrode group can he inserted into the case through its opening portion. The opening portion of the case can be covered with, for example, a lid-like cover plate.

As described above, in the rectangular electricity storage device of the embodiment, the insulation sheet providing insulation between the electrode group and the case is not shaped into a bag for housing the electrode group by thermal welding or the like. Rather, the insulation sheet is merely folded so as to cover the lower surface and four lateral surfaces of the electrode group. Such a step can be easily incorporated into the assembly line of rectangular electricity storage devices. For this reason, the embodiment enables simplification of production of rectangular electricity storage devices. In addition, the embodiment enables suppression of an increase in the scale of the facility for producing rectangular electricity storage devices and an increase in the complexity of the production process. This facilitates a reduction in the production Costs of rectangular electricity storage devices.

Here, regarding the number of insulation sheets for covering the lower surface and four lateral surfaces of the electrode group, from the viewpoint of a reduction in the number of components of the electricity storage device and simplification of the production of the electricity storage device, a single insulation sheet is preferably used. However, for example, two insulation sheets may be used: one of the sheets is used to cover a portion (for example, a half) of the electrode group that should be covered, and the other sheet is used to cover the remaining portion of the electrode group that should be covered. Similarly, three or more insulation sheets may be used so as to cover different portions of the electrode group that should be covered. Such an insulation sheet is not limited to a monolayer structure and may have a multilayer structure in which layers of two or more materials are placed an top of one another. Two or more insulation sheets may be used in the form of being placed on top of one another.

The four lateral surfaces of the electrode group are all preferably covered by such an insulation sheet. However, portions of the four lateral surfaces of the electrode group, the portions being not directly facing the case, are not necessarily covered by the insulation sheet. The insulation sheet may also cover at least a portion of the upper surface of the electrode group. The lower surface of the electrode group is all preferably covered by the insulation sheet.

The electrode group may be, for example, a multilayer body prepared by stacking sheet-shaped positive electrodes and sheet-shaped negative electrodes with separators interposed therebetween, or a wound body prepared by winding a positive electrode and a negative electrode with a separator interposed therebetween. When the electrode group is a multilayer body, it typically has the Shape of a prism resembling a rectangular parallelepiped (refer to FIG. 1).

Here, basically, the insulation sheet is merely folded, and does not have any welded portion that joins together one portion and another portion of the insulation sheet. When two or More insulation sheets are used, the insulation sheets do not have any welded portion that joins together one and another of the insulation sheets. However, for example, an adhesive tape may he used to keep the folded shape of an insulation sheet.

The material for the insulation sheet is not particularly limited, but is preferably an insulating resin. Examples of the resin include polyolefins such as polyethylene (PE), polypropylene (PP), and ethylene-propylene copolymers; polyester resins such as polyethylene terephthalate (PET), polybutylene terephthalate (PBT), and polycarbonate (PC); polyether resins such as polysulfone (PS), polyether sulfone (PES), and polyphenylene ether (PPE); polyphenylene sulfide resins such as polyphenylene sulfide (PPS) and polyphenylene sulfide ketone; polyamide resins such as aromatic polyamide resins (such as aramid resins); polyimide resins; and cellulose resins. These may be used alone or in combination of two or more thereof.

The insulation sheet may be formed of a fluororesin. When the rectangular electricity storage device is, for example, a molten salt battery, the rectangular electricity storage device can be used in a relatively high temperature range (for example, 0 to 90° C.). Fluororesins have high heat resistance. For this reason, even when the rectangular electricity storage device is used in a relatively high temperature range, an insulation sheet formed of a fluororesin can he prevented from being softened by heat. On the other hand, when the rectangular electricity storage device is used in a temperature range of, for example, 80° C. or lower, the insulation sheet is not necessarily formed of a highly heat resistant material, and the insulation sheet may be formed of a more inexpensive material, PP or PE.

Incidentally, it is difficult to shape insulation sheets formed of fluororesins so as to have bag shapes by fusion. In the embodiment, such an insulation sheet is not shaped so as to have a bag shape by fusion, but is merely folded so as to surround the electrode group. For this reason, in the embodiment, fluororesins, which have been difficult to use for such an application due to unsuitability for fusion, can DOW be easily used as materials for the insulation sheets.

Such a fluororesin is a homopolymer or copolymer having a fluorine-containing monomer unit. Examples of the fluororesin include polytetrafluoroethylene (PUT), tetrafluoroethylene-hexafluoropropylene copolymers, tetrafluoroethylene-perfluoroalkyl vinyl ether copolymers (PFA), tetrafluoroethylene-ethylene copolymers, polyvinylidene fluoride (PVDF), and polyvinyl fluoride (PVF). From the viewpoint a enhancing the heat resistance, the fluororesin preferably has a melting point of 200° C. or higher.

The type of the electricity storage device to which the present invention is applied is not particularly limited. The present invention is applicable to, for example, electricity storage devices employing nonaqueous electrolytes, such as alkali metal ion secondary batteries and alkali metal ion capacitors; and electricity storage devices employing aqueous electrolytes, such as alkali storage batteries, lead storage batteries, and electric double layer capacitors. In particular, the present invention is preferably applied to, for example, sodium ion secondary batteries, lithium ion secondary batteries, sodium ion capacitors, and lithium ion capacitors.

In the positive electrode and negative electrode of an alkali metal ion secondary battery, for example, Faradaic reactions involving alkali metal ions (sodium ions or lithium ions) proceed. In the case of an alkali metal ion capacitor, a non-Faradaic reaction of adsorption of anions in the electrolyte proceeds in the positive electrode, while a Faradaic reaction involving alkali metal ions proceeds in the negative electrode.

The electrolyte may be prepared so as to contain, for example, an organic electrolyte, and a molten salt and/or an additive. The organic electrolyte contains an organic solvent and an alkali metal salt dissolved in the organic solvent. The molten salt means the same as salt being melted and is also referred to as ionic liquid. The ionic liquid is a liquid ionic substance constituted by an anion and a cation. When the electricity storage device is used at a relatively high temperature, the electrolyte preferably has a molten salt content: of 90 mass % or more. On the other hand, when the electricity storage device is mainly used in an ordinary temperature range (for example, −5 to 40° C.), the electrolyte preferably has an organic electrolyte content of 80 mass % or more, and the electrolyte preferably has an organic solvent content of 50 mass % or more.

A lithium ion secondary battery and/or lithium ion capacitor in which the main component of the electrolyte is an organic solvent is used in an ordinary temperature range (for example, −5 to 40° C.). In such a rectangular electricity storage device, a polyolefin such as PE or PP can be preferably used as the material of the insulation sheet. When a sodium ion secondary battery is used in an ordinary temperature range, PE or PP can also be preferably used as the material of the insulation sheet. When the insulation sheet is formed of polyolefin the insulation sheet preferably has a thickness DTI of 0.05 to 0.2 mm. When the insulation sheet has a thickness in this range, the insulation sheet merely folded can more suitably prevent internal short-circuits in the electricity storage device.

On the other hand, when the insulation sheet is formed of fluororesin, the insulation sheet preferably has a thickness DT2 of 0.05 to 0.5 mm. Alternatively, the insulation sheet is not limited to the above-described resin sheets, and may be formed of, for example, cellulose or paper.

The insulation sheet is preferably a sheet having the shape of a rectangle (that may be a square). In this case, excess portions in the folded state (for example, in FIG. 3, a triangular portion between a region A3 and a region A5) may be cut off. However, from the viewpoint of maintaining the insulation sheet so as to have a sufficient strength, such portions are preferably left uncut.

When the insulation sheet has the shape of a rectangle having first sides and second sides orthogonal to the first sides, the insulation sheet includes a first region including a central portion of the insulation sheet and covering the lower surface of the electrode group, second regions individually folded back along two opposite sides of the lower surface so as to cover two lateral surfaces out of the four lateral surfaces of the electrode group, and third regions folded back along other two opposite sides of the lower surface of the electrode group and along boundaries between the four lateral surfaces so as to cover other two lateral surfaces out of the four lateral surfaces.

The rectangular electricity storage device of the embodiment can include a positive-electrode external terminal and a negative-electrode external terminal that are electrically insulated from each other and disposed on the cover plate. The positive electrode and the positive-electrode external terminal can be electrically connected through a positive-electrode lead piece. The negative electrode and the negative-electrode external terminal can be electrically connected through a negative-electrode lead piece. An insulating partition member is preferably disposed between the electrode group and the cover plate. The partition member is preferably a three-dimensional member. For example, the partition member includes a bottom plate disposed so as to face the electrode group, and at least one upright plate disposed so as to extend from the periphery of the bottom plate. The bottom plate includes a first opening through which the positive-electrode lead piece extends, and a second opening through which the negative-electrode lead piece extends. At least one upright plate is interposed between the ease and the positive-electrode lead piece and/or negative-electrode lead piece. The presence of such an upright plate of a three-dimensional insulating partition member, the upright plate being interposed between the case and the positive-electrode lead piece and/or negative-electrode lead piece, enables highly reliable prevention of occurrence of short circuits within the electricity storage device.

A method for producing a rectangular electricity storage device according to an embodiment of the present invention includes (a) a step of preparing a prism-shaped electrode group with an upper surface, a lower surface, and four lateral surfaces, the electrode group including a positive electrode, a negative electrode, and a separator interposed between the positive electrode and the negative electrode; (b) a step of preparing an electrolyte; (c) a step of preparing a case with an opening portion, the case being used for housing the electrode group and the electrolyte; (d) a step of preparing a cover plate for covering the opening portion of the case; (e) a step of preparing an insulation sheet for being interposed between the electrode group and the case so as to insulate the electrode group and the case from each other; (f) a step of folding the insulation sheet so as to surround the lower surface and the four lateral surfaces of the electrode group; and (g) a step of placing the electrode group and the folded insulation sheet into the case such that the insulation sheet is interposed between the electrode group and the case.

The above-describe steps (a) to (g) can all be incorporated into the conventional assembly line for rectangular electricity storage devices. Therefore, major modifications are not required for the line in order to produce rectangular electricity storage devices.

As described above, the insulation sheet typically has the shape of a rectangle (that is a rectangle in a broad sense and may be a square) having first sides and second sides orthogonal to the first sides. In this case, when the lower surface of the electrode group has the shape of a rectangle (that is a rectangle in a narrow sense) haying lung sides and short sides, the lengths of the first sides of the insulation sheet are set to be larger than the lengths of the long sides of the lower surface of the electrode group (maximum width of the electrode group). In other words, at least one of two sides of the insulation sheet, the two sides being orthogonal to each other, is set to be longer than the maximum width of the electrode group. When the insulation sheet has the shape of a rectangle in the narrow sense, at least the long sides are set to be longer than the maximum width of the electrode group. When the insulation sheet has the shape of a square, the lengths of all the sides of the insulation sheet are set to he larger than the maximum width of the electrode group.

In this case, when the rectangular electricity storage device has an upright shape as illustrated in FIG. 1, the length of a short side (XI, refer to FIG. 3) of the insulation sheet is set to be larger than the maximum width (long side of the lower surface) of the electrode group. On the other hand, when the rectangular electricity storage device is, as illustrated in FIG. 8, an electricity storage device 110 having a wide case 14A, and a width W1 of an electrode group 12A is at least twice longer than a height H1, the maximum width (W1) of the electrode group may be larger than the length of the short side of the insulation sheet. Even in this case, the length of a long side of the insulation sheet is set to be larger than the maximum width of the electrode group.

The step (f) includes a substep (f1) of contacting the lower surface of the electrode group and the insulation sheet each other such that a long side of the lower surface of the electrode group is orthogonal to a second side Y1 of the insulation sheet (refer to FIG. 3), and the center of the lower surface is positioned at the center of the insulation sheet; a substep (f2) of folding back the insulation sheet individually along two long sides of the lower surface; substep (f3) of folding back the insulation sheet individually along two short sides of the lower surface; and a substep (f4) of folding back the insulation sheet individually along boundaries between the four lateral surfaces. Incidentally, regarding the substep (f3) and the substep (f4), the substep (f3) may be performed earlier, or the substep (f4) may be performed earlier. In the manner of folding the insulation sheet described later in detail with reference to FIG. 4A to FIG. 4E, the substep (f3) is performed earlier.

Incidentally, “orthogonal” used here does not necessarily mean that the long side of the lower surface of the electrode group and the second side of the insulation sheet exactly form an angle of 90°. When this angle is at or near 90° (for example, 80 to 100°), the long side of the lower surface of the electrode group is regarded as being orthogonal to the second side of the insulation sheet. In addition, “the center of the lower surface of the electrode group is positioned at the center of the insulation sheet” does not necessarily mean that these centers are exactly at the same position. When the deviation between these centers is small (for example, 5 mm or less), the center of the lower surface of the electrode group is regarded as being positioned at the center of the insulation sheet.

Hereinafter, the rectangular electricity storage device and the production method therefor will be specifically described with reference to drawings.

FIG. 1 is an exploded perspective view schematically illustrating the configuration of a rectangular electricity storage device according to an embodiment of the present invention. This illustrated example, a rectangular electricity storage device 10, is a rectangular sodium ion secondary battery or lithium ion capacitor, and includes a prism-shaped electrode group 12, a rectangular case 14 with an opening portion, and a cover plate 16 covering the opening portion of the case 14. The case 14 and the cover plate 16 are formed of metal and have conductivity.

An insulating partition member 18 is disposed between the upper surface of the electrode group 12 and the cover plate 16. An insulation sheet 20 is disposed between the electrode group 12 and the case 14. Incidentally, in FIG. 1 in order to more clearly illustrate the internal structure of the electricity storage device, the insulation sheet 20 is partially cut away such that an upper portion of the four lateral surfaces of the electrode group 12 is exposed from the insulation sheet 20. However, actually in this embodiment, in order to prevent internal short-circuits in the electricity storage device, the insulation sheet 20 covers the entirety of the four lateral surfaces of the electrode group 12 to the upper end.

The cover plate 16 may be equipped with a positive-electrode external terminal 40 and a negative-electrode external terminal 42. The positive-electrode external terminal 40 is disposed at a position close to a longitudinal end (in the Y-axis direction) of the cover plate 16; and the negative-electrode external terminal 42 is disposed at a position close to the other end. These external terminals are electrically insulated from the cover plate 16.

In the central portion of the cover plate 16, a relief valve 44 (such as a breaker valve) may be provided, that enables release of gas from inside of the case 14 when the internal pressure of the case abnormally increases. In the region near the relief valve 44, a pressure control valve 46 and an electrolyte inlet 48 may be provided. The electrolyte inlet 48 is an inlet through which the electrolyte is injected into the case 14 after the cover plate 16 is attached to the opening portion of the case 14. The electrolyte inlet 48 is scaled with a plug (not shown).

In the embodiment, the electrode group 12 includes a multilayer body in which positive electrodes and negative electrodes are alternately stacked. The electrode group 12 has an upper surface, a lower surface, and four flat lateral surfaces. The positive electrodes and negative electrodes that constitute the electrode group 12 will be described later in detail. The electrode group 12 has an outer shape that is the shape of a prism resembling a rectangular parallelepiped. In the embodiment, the electrode group 12 is constituted by plural (four in the illustrated example) sub-groups 12a, 12b, 12c, and 12d.

FIG. 2 is a sectional view of a sub-group of the electrode group. This sectional view is a sectional view of the sub-group 12a taken along a plane that includes line I1-I1 in FIG. 1 and that is perpendicular to the Y axis, viewed in the direction of the arrows. Incidentally, the number of illustrated electrodes (positive electrodes and negative electrodes) does not necessarily match the number of electrodes actually included in the sub-group 12a. The other sub-groups 12b to 12d each have the same configuration as the sub-group 12a.

The sub-group 12a of the electrode group 12 is constituted by, for example, plural positive electrodes 22 housed in bag-shaped separators 21 and plural negative electrodes 24 that are alternately stacked. Each positive electrode 22 includes a positive-electrode current collector and a positive-electrode active material. Each negative electrode 24 includes a negative-electrode current collector and a negative-electrode active material. In FIG. 2, the positive-electrode current collector, the negative-electrode current collector, the positive-electrode active material, and the negative-electrode active material are not illustrated as being distinguishable from the electrodes.

An upper end portion of each of the plural positive electrodes 22 (or the positive-electrode current collectors) is equipped with a lead piece (positive-electrode lead piece) 26. The positive-electrode lead piece 26 may be formed as a single unit together with the positive electrode 22 or the positive-electrode current collector. The lead pieces of the plural positive electrodes 22 of the sub-group 12a are bundled together, for example, welded together, so that these positive electrodes 22 are connected in parallel.

A bundle portion 26A of the positive-electrode lead pieces 26 (hereafter, referred to as a positive-electrode lead piece bundled portion) is connected to a conductive positive-electrode connection member 30 (refer to FIG. 1), and electrically connected via the positive-electrode connection member 30 to the positive-electrode external terminal 40. The other sub-groups 12b to 12d each also have such a positive-electrode lead piece bundled portion 26A. These positive-electrode lead piece bundled portions 26A are also each connected to the positive-electrode connection member 30, and connected via the positive-electrode connection member 30 to the positive-electrode external terminal 40. Such a configuration enables parallel connections of all the positive electrodes 22 of the electrode group 12 to the positive-electrode external terminal 40.

An upper end portion of each of the plural negative electrodes 24 (or the negative-electrode current collectors) is equipped with a lead piece (negative-electrode lead piece) 28. The negative -electrode lead piece 28 may be formed as a single unit together with the negative electrode 24, and disposed at the upper end portion of the negative electrode 24 or the negative-electrode current collector. The lead pieces of the plural negative electrodes 24 of the sub-group 12a are bundled together, for example, welded together, so that the plural negative electrodes 24 are connected in parallel.

A bundle portion 28A of the negative-electrode lead pieces 28 (hereafter, referred to as a negative-electrode lead piece bundled portion) is connected to a conductive negative-electrode connection member 32 (refer to FIG. 1), and electrically connected via the negative-electrode connection member 32 to the negative-electrode external terminal 42. The other sub-groups 12b to 12d each also have such a negative-electrode lead piece bundled portion 28A. These negative-electrode lead piece bundled portions 28A are also connected to the negative-electrode connection member 32, and connected via the negative-electrode connection member 32 to the negative-electrode external terminal 42. Such a configuration enables parallel connections of all the negative electrodes 24 of the electrode group 12 to the negative-electrode external terminal 42.

The partition member 18 is disposed between the upper surface of the electrode group 12 and the cover plate 16 in order to prevent the positive-electrode lead piece bundled portions 26A, the negative-electrode lead piece bundled portions 28A, the positive-electrode connection member 30, and the negative-electrode connection member 32 from contacting the conductive case 14. The partition member 18 includes a bottom plate 18a, which has a substantially rectangular outer shape, and four upright plates 18b, which stand on the four sides of the bottom plate 18a so as to be perpendicular to the bottom plate 18a. The bottom plate 18a and the four upright plates 18b can be formed as a single unit. The boundary portions between the bottom plate 18a and the upright plates 18b are preferably formed as grooved thin portions to thereby be easily bent. As a result, such a three-dimensional partition member 18 can be easily formed from a single plate member.

The bottom plate 18a has a first opening 18c through which the positive-electrode lead piece bundled portions 26A of the sub-groups 12a to 12d individually extend, and a second opening 18d through which the negative-electrode lead piece bundled portions 28A of the sub-groups 12a to 12d individually extend. The four upright plates 18b surround the positive-electrode lead piece bundled portions 26A, the negative-electrode lead piece bundled portions 28A, the positive-electrode connection member 30, and the negative-electrode connection member 32 to thereby prevent these conductive members from contacting the case 14.

FIG. 3 is a plan view of the insulation sheet in its unfolded state. The insulation sheet: 20 in its unfolded state has the shape of, for example, a rectangle and includes a region A1 (corresponding to the first region) for covering the lower surface of the prism-shaped electrode group 12; regions A2 (corresponding to the second regions) for covering two opposite lateral surfaces out of the four lateral surfaces of the prism-shaped electrode group 12; and regions A3, regions A4, and regions A5 (these three regions, regions A3 to A5, correspond to the third regions) for covering the other two opposite lateral surfaces out of the four lateral surfaces of the prism-shaped electrode group 12. The region A1 includes the central portion of the insulation sheet 20.

The insulation sheet 20 is subjected to formation of first folds F1 individually corresponding to two opposite sides of the lower surface of the electrode group 12, and second folds F2 individually corresponding to the other two opposite sides of the lower surface. The region surrounded by the two first folds F1 and the two second folds F2 is the region A1. The two first folds F1 are perpendicular to the second side Y1 (long side in the illustrated example) of the insulation sheet 20. The two second folds F2 are perpendicular to the first side X1 (short side in the illustrated example) of the insulation sheet 20.

The insulation sheet 20 is also subjected to formation of four third folds F3, which extend along extensions from the two first folds F1 to the second sides Y1. A region surrounded by a single second fold F2 and its adjacent two third folds F3 is a region A3. The insulation sheet 20 is also subjected to formation of four fourth folds F4, which extend along line segments extending at 45° with respect to the third folds F3. In addition, the insulation sheet 20 is subjected to formation of four fifth folds F5, which individually correspond to the boundary lines between four lateral surfaces of the electrode group 12.

Hereinafter, description will be made with reference to drawings, regarding the step of folding the insulation sheet 20 so as to surround the lower surface and four lateral surfaces of the electrode group 12.

FIGS. 4A to 4E are perspective views illustrating an example of the step of folding the insulation sheet so as to surround the lower surface and four lateral surfaces of the electrode group. However, such a step of folding the insulation sheet is not limited to the step illustrated in FIGS. 4A to 4E.

As illustrated in FIG. 4A, for example, the insulation sheet 20 having the shape of a rectangle is first prepared by unwinding from a roll and cutting in a predetermined length; and an intermediate product 34 is placed on the insulation sheet 20, the intermediate product 34 including the electrode group 12, the cover plate 16, and the partition member 18. At this time, the intermediate product 34 is placed on the insulation sheet 20 such that the whole lower surface of the electrode group 12 faces the region A1 of the insulation sheet 20.

In the intermediate product 34, plural positive-electrode lead piece bundled portions 26A are connected to the positive-electrode connection member 30, so that all the positive electrodes of the electrode group 12 are electrically connected to the positive-electrode external terminal 40. Similarly, plural negative-electrode lead piece bundled portions 28A are connected to the negative-electrode connection member 32, so that all the negative electrodes of the electrode group 12 are electrically connected to the negative-electrode external terminal 42. The electrode group 12 has a pair of opposite lateral surfaces SF1 having a larger area and the other pair of opposite lateral surfaces SF2 having a smaller area.

Subsequently, as illustrated in FIG. 4B, the insulation sheet 20 is folded back individually along the two first folds F1. As a result, the two regions A2 of the insulation sheet 20 cover the two lateral surfaces SF1 of the electrode group 12.

Subsequently, as illustrated in FIG. 4C, the insulation sheet 20 is folded back individually along the two second folds F2. As a result, the two regions A3 of the insulation sheet 20 cover the lower portions of the two lateral surfaces SF2. At this time, the insulation sheet 20 is subjected to formation of folds individually along the four third folds F3 and also subjected to formation of folds individually along the four fourth folds F4.

Subsequently, as illustrated in FIG. 4D, the insulation sheet 20 is folded back individually along two fifth folds F5 (F5A) around one of the regions A2. As a result, the remaining portions of the two lateral surfaces SF2 not covered by the regions A3 are mostly covered by the two regions A4 of the insulation sheet 20.

As illustrated in FIG. 4E, the insulation sheet 20 is folded back individually along two fifth folds FS (F5B) around the other region A2 (not shown). As a result, the remaining portions of the two lateral surfaces SF2 not covered by the regions A3 and the regions A4 are all covered by the two regions A5 of the insulation sheet 20. As a result of the step of folding the insulation sheet having been described so far, the lower surface and four lateral surfaces of the electrode group 12 constituting the intermediate product 34 are all covered by the insulation sheet 20. Incidentally, the substeps in FIG. 4D and FIG. 4E may be performed before the substep in FIG. 4C. In this case, contrary to the state in FIG. 4E, the regions A3 are placed on lower portions of the regions A4 and regions A5.

Subsequently, as illustrated in FIG. 5, the intermediate product 34 having been subjected to the step of folding the insulation sheet, is inserted, with the lower portion of the electrode group 12 as the leading end, through the opening portion of the case 14 into the case 14. FIG. 6 illustrates the state in which the electrode group and the partition member constituting the intermediate product are housed in the case. In the state illustrated in FIG. 6, for example, the peripheral portion of the cover plate 16 is welded to the opening portion of the case 14, so that the cover plate 16 is joined to the opening portion of the case 14. After that, an electrolyte is injected through the electrolyte inlet 48 into the case 14. After the injection of the electrolyte is completed, the electrolyte inlet 48 is plugged, to thereby seal the case 14.

FIG. 7 illustrates an example of the outer shape of an electrode group that is a wound body prepared by winding a positive electrode and a negative electrode with a separator interposed therebetween. A wound body 100 in FIG. 7 includes an upper surface 101, a lower surface 102, two parallel and flat lateral surfaces 103 and 104, and a pair of curved lateral surfaces 105 and 106. Incidentally, in the embodiment, the electrode group may be constituted by a single wound body 100; or plural sub-groups may each be constituted by a single wound body 100, and the plural sub-groups may constitute the electrode group.

Hereinafter, electrodes and an electrolyte serving as power-generation elements of a sodium ion secondary battery or a lithium ion capacitor will be described. The positive electrode 22 or the negative electrode 24 is formed in the following manner: for example, a current collector constituted by a metal foil or a metal porous body is coated or filled with an electrode mixture, and optionally the current collector and the electrode mixture are compressed in the thickness direction. The electrode mixture contains an active material as an essential component and may contain a conductive assistant and/or a binder as an optional component.

The negative-electrode active material of a sodium ion secondary battery can be a material that reversibly occludes and releases sodium ions. Examples of such a material include carbon material, spinel-type lithium titanium oxide, spinel-type sodium titanium oxide, silicon oxide, silicon alloy, tin oxide, and tin alloy. Such carbon material is preferably non-graphitizable carbon (hard carbon). The negative-electrode active material of a lithium ion capacitor can be a material that reversibly occludes and releases lithium ions. Examples of such a material include carbon material, spinel-type lithium titanium oxide, silicon oxide, silicon alloy, tin oxide, and tin alloy. Preferred examples of the carbon material include graphite, non-graphitizable carbon, and graphitizable carbon.

The positive-electrode active material of a sodium ion secondary battery is preferably a transition metal compound that reversibly occludes and releases sodium ions. The transition metal compound is preferably a sodium-containing transition metal oxide (such as NaCrO₂). The positive-electrode active material of a lithium ion capacitor is preferably a porous material (such as activated carbon) that reversibly adsorbs and desorbs anions.

The electrolyte used for a sodium ion secondary battery preferably contains a molten salt. The molten salt contains the salt of a sodium ion and an anion (first anion). Examples of the first anion include fluorine-containing acid anions such as PF₆⁻ and BF₄⁻), a chlorine-containing acid anion (ClO₄⁻), a bissulfonylamide anion, and a trifluoromethanesulfonate anion (CF₃SO₃⁻).

The electrolyte used for a sodium ion secondary battery may contain, in addition to the molten salt, for example, an organic solvent and/or an additive. From the viewpoint of enhancement of heat resistance, the molten salt (ionic substance constituted by an anion and a cation) preferably accounts for 90 mass % or more, further 100 mass %, of the electrolyte.

The molten salt preferably contains, as cations, in addition to sodium ions, organic cations. Examples of the organic cations include nitrogen-containing cations, sulfur-containing cations, and phosphorus-containing cations. The counter anions (second anions) for the organic cations are preferably bissulfonylamide anions.

Preferred examples of the bissulfonylamide anions include a bis(fluorosulfonyl)amide anion (N(SO₂F)₂⁻) (FSA⁻); a bis(trifluoromethylsulfonyl)amide anion (N(SO₂CF₃)₂⁻) (TFSA⁻), and a (fluorosulfonyl)(trifluoromethylsulfonyl)amide anion (N(SO₂F)(SO₂CF₃)⁻).

Examples of the nitrogen-containing cations include quaternary ammonium cations, pyrrolidinium cations, and imidazolium cations.

Examples of the quaternary ammonium cations include tetraalkylammonium cations (in particular, for example, tetra C₁₋₅ alkylammonium cations) such as a tetraethylammonium cation (TEA⁺) and a methyltriethylammonium cation (TEMA⁺).

Examples of the pyrrolidinium cations include a 1-methyl-1-propylpyrrolidinium cation (Py13⁺), a 1-butyl-1-methylpyrrolidinium cation (Py14⁺), and a 1-ethyl-1-propylpyrrolidinium cation. Examples of the imidazolium cations include a 1-ethyl-3-methylimidazolium cation (EMI⁺) and a 1-butyl-3-methylimidazolium cation (BMI⁺).

The ratio of sodium ions to the total of sodium ions and organic cations of the molten salt is preferably 10 mol % or more, more preferably 30 mol % or more. The ratio is preferably 90 mol % or less, more preferably 80 mol % or less.

The electrolyte used for a lithium ion capacitor is preferably an organic electrolyte. The organic electrolyte contains an organic solvent and a lithium salt dissolved in the organic solvent. Examples of the lithium salt include LiPF₆, LiBF₄, LiClO₄, lithium bissulfonylamide (LiFSA), and lithium trifluoromethanesulfonate (LiCF₃SO₃). Examples of the organic solvent include cyclic carbonates (such as ethylene carbonate and propylene carbonate), chain carbonates (such as diethyl carbonate, dimethyl carbonate, and ethyl methyl carbonate), cyclic carboxylic acid esters, and chain carboxylic acid esters.

The electrolyte used for a lithium ion capacitor may contain, in addition to the organic solvent and the lithium salt, for example, a molten salt and/or an additive. However, from the viewpoint of enhancement of rate characteristics at low temperature, the organic solvent and the lithium salt preferably account for 80 mass % or more, further 100 mass %.

As has been described, in the embodiment, the insulation sheet disposed between the electrode group and the conductive case is not shaped into a bag by thermal welding or the like. Rather, the insulation sheet is merely folded so as to surround the lower surface and four lateral surfaces of the electrode group. This facilitates simplification of the production steps and production facility for rectangular electricity storage devices.

The scope of the present invention is not limited to the above-described content and is indicated by Claims. The scope of the present invention is intended to embrace all the modifications within the meaning and range of equivalency of the Claims. For example, the above-described embodiment relates to a case where the rectangular electricity storage device is a sodium ion secondary battery or a lithium ion capacitor. However, the present invention is not limited to this embodiment and is applicable to various rectangular electricity storage devices such as lithium ion secondary batteries and sodium ion capacitors.

### INDUSTRIAL APPLICABILITY

A rectangular electricity storage device and a production method therefor according to the present invention are useful for, for example, household or industrial large-scale power storage devices and power sources mounted on electric vehicles and hybrid vehicles.

### REFERENCE SIGNS LIST

10 rectangular electricity storage device; 12 electrode group; 12a to 12d sub-groups; 14 case; 16 cover plate; 18 partition member; 18a bottom plate; 18b upright plate; 18c first opening; 18d second opening; 20 insulation sheet; 21 bag-shaped separator; 22 positive electrode; 24 negative electrode; 26 positive-electrode lead piece; 26A positive-electrode lead piece bundled portion; 28 negative-electrode lead piece; 28A negative-electrode lead piece bundled portion; 30 positive-electrode connection member; 32 negative-electrode connection member; 34 intermediate product; 40 positive-electrode external terminal; 42 negative-electrode external terminal; 44 relief valve; 46 pressure control valve; 48 electrolyte inlet; 100 wound body

1. A rectangular electricity storage device comprising:
a prism-shaped electrode group with an upper surface, a lower surface, and four lateral surfaces, the electrode group including a positive electrode, a negative electrode, and a separator interposed between the positive electrode and the negative electrode;
an electrolyte;
a case with an opening portion, the case housing the electrode group and the electrolyte;
a cover plate covering the opening portion of the case; and
an insulation sheet interposed between the electrode group and the case, and electrically insulating the electrode group and the case from each other,
wherein the insulation sheet is folded so as to surround the lower surface and the four lateral surfaces of the electrode group.

2. The rectangular electricity storage device according to claim 1, wherein the insulation sheet does not have any welded portion that joins together one portion and another portion of the insulation sheet.

3. The rectangular electricity storage device according to claim 1, wherein the insulation sheet in its unfolded state has a shape of a rectangle, and includes
a first region including a central portion of the rectangle and covering the lower surface of the electrode group,
second regions individually folded back along two opposite sides of the lower surface so as to cover two lateral surfaces out of the four lateral surfaces, and
third regions folded back along other two opposite sides of the lower surface and along boundaries between the four lateral surfaces so as to cover other two lateral surfaces out of the four lateral surfaces.

4. The rectangular electricity storage device according to claim 1, comprising:
a positive-electrode external terminal and a negative-electrode external terminal that are electrically insulated from each other and disposed on the cover plate;
a positive-electrode lead piece electrically connecting the positive electrode and the positive-electrode external terminal to each other;
a negative-electrode lead piece electrically connecting the negative electrode and the negative-electrode external terminal to each other; and
an insulating partition member disposed between the electrode group and the cover plate,
wherein the partition member includes a bottom plate disposed so as to face the electrode group, and at least one upright plate disposed so as to extend from a periphery of the bottom plate,
the bottom plate includes a first opening through which the positive-electrode lead piece extends, and a second opening through which the negative-electrode lead piece extends, and
the at least one upright plate is interposed between the case and at least one lead piece out of the positive-electrode lead piece and the negative-electrode lead piece.

5. A method for producing a rectangular electricity storage device, the method comprising:
(a) a step of preparing a prism-shaped electrode group with an upper surface, a lower surface, and four lateral surfaces, the electrode group including a positive electrode, a negative electrode, and a separator interposed between the positive electrode and the negative electrode;
(b) a step of preparing an electrolyte;
(c) a step of preparing a case with an opening portion, the case being used for housing the electrode group and the electrolyte;
(d) a step of preparing a cover plate for covering the opening portion of the case;
(e) a step of preparing an insulation sheet for being interposed between the electrode group and the case so as to electrically insulate the electrode group and the case from each other;
(f) a step of folding the insulation sheet so as to surround the lower surface and the four lateral surfaces of the electrode group; and
(g) a step of placing the electrode group and the folded insulation sheet into the case such that the insulation sheet is interposed between the electrode group and the case.

6. The method for producing a rectangular electricity storage device according to claim 5, wherein the insulation sheet has a shape of a rectangle including first sides and second sides orthogonal to the first sides,
the lower surface of the electrode group has a shape of a rectangle including long sides and short sides,
the first sides of the insulation sheet are longer than the long sides of the lower surface, and
the step (f) includes
contacting the lower surface and the insulation sheet to each other such that the long sides of the lower surface are orthogonal to the second sides of the insulation sheet, and a center of the lower surface is positioned at a center of the insulation sheet,
folding back the insulation sheet individually along the two long sides of the lower surface,
folding back the insulation sheet individually along the two short sides of the lower surface, and
folding back the insulation sheet along boundaries between the four lateral surfaces.
